(19) United States
(12) Patent Application Publication
(10) Pub. No.: US 2025/0133267 A1
(43) Pub. Date: Apr. 24, 2025

(54) MULTI-PERSON COLLABORATION-BASED RESOURCE PROCESSING METHOD, APPARATUS AND SYSTEM

(71) Applicant: Shanghai Hode Information Technology Co., Ltd., Shanghai (CN)

(72) Inventors: Xiang CAO, Shanghai (CN); Yaqin HUANG, Shanghai (CN); Tianpeng ZHOU, Shanghai (CN); Haoran WANG, Shanghai (CN)

(21) Appl. No.: 18/682,676

(22) PCT Filed: Jun. 16, 2022
(86) PCT No.: PCT/CN2022/099270

§ 371 Date: Feb. 9, 2024

(30) Foreign Application Priority Data
Aug. 17, 2021 (CN) 202110945354.3

(51) Int. Cl. H04N 21/472; H04N 21/234; H04N 21/458

(52) U.S. Cl. CPC H04N 21/472; H04N 21/234; H04N 21/458

(57) ABSTRACT

This application provides a method, apparatus, and system of processing resources based on multi-person collaboration. The method is applied to a storyboard collaborative creation system that includes a server device and at least two client devices. The at least two client devices each receive a server resource of a target story sent from the server device, store the server resource as a local resource, receive an editing instruction for the local resource, obtain information to be responded, and send the information to the server device. The server device edits the server resource based on the information to be responded sent from the at least two client devices, to generate a target resource of the target story, and sends the target resource to the at least two client devices. The at least two client devices each receive the target resource, and update the local resource based on the target resource.

This application claims priority to Chinese Patent Application No. 202110945354.3, filed with the China National Intellectual Property Administration on Aug. 17, 2021, and entitled “MULTI-PERSON COLLABORATION-BASED RESOURCE PROCESSING METHOD, APPARATUS, AND SYSTEM”, which is incorporated herein by reference in its entirety.

### TECHNICAL FIELD

This application relates to the field of computer technologies, and in particular, to a multi-person collaboration-based resource processing method. This application also relates to a multi-person collaboration-based resource processing apparatus and system, a computing device, a computer-readable storage medium, and a computer program.

### BACKGROUND

Currently, in the market, a product that enables a storyboard script to be edited through multi-person collaboration does not have a high degree of collaboration, and the storyboard script can be generally edited only by using an exclusive lock. Only after a user completes editing of a specific shot, the shot can be transferred to another user to edit. As a result, a plurality of persons cannot simultaneously edit a same shot, user experience of editing the storyboard script through collaboration is poor, and working efficiency is low.

### SUMMARY

In view of this, embodiments of this application provide a multi-person collaboration-based resource processing method. This application also relates to a multi-person collaboration-based resource processing apparatus and system, a computing device, a computer-readable storage medium, and a computer program, to resolve a problem in the conventional technology that working efficiency is low in a scenario in which a storyboard script is edited through multi-person collaboration.

According to a first aspect of the embodiments of this application, a multi-person collaboration-based resource processing method is provided, applied to a storyboard collaborative creation system, where the system includes a server device and at least two client devices, and the method includes:
receiving, by the at least two client devices, a server resource that is of a target story and that is sent by the server device, storing the server resource as a local resource, receiving an editing instruction for the local resource, obtaining information to be responded, and sending the information to be responded to the server device;
editing, by the server device, the server resource based on the information to be responded sent by the at least two client devices, to generate a target resource of the target story, and sending the target resource to the at least two client devices; and
receiving, by the at least two client devices, the target resource, and updating the local resource with the target resource.

According to a second aspect of the embodiments of this application, a multi-person collaboration-based resource processing system is provided, including a server device and at least two client devices, where
the at least two client devices are configured to receive a server resource that is of a target story and that is sent by the server device, store the server resource as a local resource, receive an editing instruction for the local resource, obtain information to be responded, and send the information to be responded to the server device;
the server device is configured to edit the server resource based on the information to be responded sent by the at least two client devices, to generate a target resource of the target story, and send the target resource to the at least two client devices; and
the at least two client devices are further configured to receive the target resource, and update the local resource with the target resource.

According to a third aspect of the embodiments of this application, a multi-person collaboration-based resource processing method is provided, applied to at least two client devices, and for each client device, including:
receiving a server resource that is of a target story and that is sent by a server device, and storing the server resource as a local resource;
receiving an editing instruction for the local resource, and obtaining information to be responded;
sending the information to be responded to the server device; and
receiving a target resource returned by the server device, and updating the local resource with the target resource.

According to a fourth aspect of the embodiments of this application, a multi-person collaboration-based resource processing method is provided, applied to a server device, and including:
sending a server resource of a target story to each client device;
receiving information to be responded sent by at least two client devices;
editing the server resource based on the information to be responded of the at least two client devices, to generate a target resource of the target story; and
sending the target resource to each client device.

According to a fifth aspect of the embodiments of this application, a multi-person collaboration-based resource processing apparatus is provided, applied to at least two client devices, and for each client device, including:
a resource receiving means, configured to receive a server resource that is of a target story and that is sent by a server device, and store the server resource as a local resource;
an instruction receiving means, configured to receive an editing instruction for the local resource, and obtain information to be responded;
an information sending means, configured to send the information to be responded to the server device; and
an update means, configured to receive a target resource returned by the server device, and update the local resource with the target resource.

According to a sixth aspect of the embodiments of this application, a multi-person collaboration-based resource processing apparatus is provided, applied to a server device, and including:
a resource sending means, configured to send a server resource of a target story to each client device;
an information receiving means, configured to receive information to be responded sent by at least two client devices;
an editing means, configured to edit the server resource based on the information to be responded of the at least two client devices, to generate a target resource of the target story; and
a sending means, configured to send the target resource to each client device.

According to a seventh aspect of the embodiments of this application, a computing device is provided, including a memory, a processor, and computer instructions stored in the memory and capable of running on the processor, where when the processor executes the computer instructions, steps of the multi-person collaboration-based resource processing method are implemented.

According to an eighth aspect of the embodiments of this application, a computer-readable storage medium is provided, where the computer-readable storage medium stores computer instructions, and when the computer instructions are executed by a processor, steps of the multi-person collaboration-based resource processing method are implemented.

According to a ninth aspect of the embodiments of this application, a computer program is provided, where when the computer program is executed on a computer, the computer is enabled to perform steps of the multi-person collaboration-based resource processing method.

The multi-person collaboration-based resource processing method provided in this application is applied to a storyboard collaborative creation system, and the system includes a server device and at least two client devices. The at least two client devices receive a server resource that is of a target story and that is sent by the server device, store the server resource as a local resource, receive an editing instruction for the local resource, obtain information to be responded, and send the information to be responded to the server device; the server device edits the server resource based on the information to be responded sent by the at least two client devices, to generate a target resource of the target story, and sends the target resource to the at least two client devices; and the at least two client devices receive the target resource, and update the local resource with the target resource. According to the multi-person collaboration-based resource processing method provided in an embodiment of this application, when a video is created through multi-person collaboration, a plurality of creators can simultaneously edit a same resource, and update a server resource on the server device based on different information to be responded, to support multi-person collaboration during video creation, thereby improving collaborative processing efficiency and improving user experience.

### BRIEF DESCRIPTION OF DRAWINGS

FIG. 1 is a flowchart of a multi-person collaboration-based resource processing method according to an embodiment of this application;

FIG. 2 is a schematic diagram of exchanging data between a client device and a server device according to an embodiment of this application;

FIG. 3 is a schematic flowchart of uploading a client device resource to a server device according to an embodiment of this application;

FIG. 4 is a schematic architectural diagram of a multi-person collaboration-based resource processing system according to an embodiment of this application;

FIG. 5 shows a multi-person collaboration-based resource processing method applied to a client device according to an embodiment of this application;

FIG. 6 shows a multi-person collaboration-based resource processing method applied to a server device according to an embodiment of this application;

FIG. 7 is a schematic diagram of a structure of a multi-person collaboration-based resource processing apparatus applied to a client device according to an embodiment of this application;

FIG. 8 is a schematic diagram of a structure of a multi-person collaboration-based resource processing apparatus applied to a server device according to an embodiment of this application; and

FIG. 9 is a block diagram of a structure of a computing device according to an embodiment of this application.

### DESCRIPTION OF EMBODIMENTS

Many specific details are described in the following description to facilitate full understanding of this application. However, this application can be implemented in many other manners different from those described herein, and a person skilled in the art can make similar promotion without departing from the connotation of this application. Therefore, this application is not limited by specific implementations disclosed below.

Terms used in one or more embodiments of this application are merely for the purpose of describing a specific embodiment, and are not intended to limit the one or more embodiments of this application. The terms “a”, “the”, and “said” of singular forms used in one or more embodiments and the appended claims of this application are also intended to include plural forms, unless otherwise specified in the context clearly. It should be further understood that the term “and/or” used in one or more embodiments of this application indicates and includes any or all possible combinations of one or more associated listed items.

It should be understood that although terms such as “first” and “second” can be used in one or more embodiments of this application to describe various types of information, the information is not limited to these terms. These terms are only used to distinguish between information of the same type. For example, without departing from the scope of one or more embodiments of this application, “first” may also be referred to as “second”, and similarly, “second” may also be referred to as “first”. Depending on the context, for example, the word “if” used herein can be interpreted as “while”, “when”, or “in response to determining”.

Terms used in one or more embodiments of this application are explained first.

A storyboard video editor is a video editor based on a storyboard script. In the storyboard video editor, a storyboard can be edited, and video shooting and video editing can be performed based on the storyboard.

A storyboard, namely, a storyboard script, is a way of organizing shooting materials based on scenes, shots, and takes. The storyboard script, also referred to as a shooting script, is a medium that converts text into a three-dimensional audiovisual image. A main task thereof is to design corresponding pictures based on voice-overs and television literary scripts, configure music and sound, and control the pacing and style of the film. One storyboard includes a plurality of scenes.

A scene describes a scenario around a story, and includes a plurality of associated shots.

A shot is a continuous segment of pictures captured from power-on to power-off, or a sequence between two editing points, where one shot includes a plurality of takes.

A take is a basic unit for taking a shot, and a material finally used is generally generated from a corresponding take of the shot.

Currently, in the market, a product that enables a storyboard script to be edited through multi-person collaboration generally does not support direct shooting on the storyboard script, and does not support multi-person real-time collaboration. Even if a product can support shooting and multi-person collaboration, only after a person completes editing of a shot, the shot can be transferred to another person for editing. In a processing procedure, there is a strict serial structure. A plurality of persons cannot simultaneously edit a same shot, user experience of collaboratively editing a storyboard script is poor, and working efficiency is low.

Based on this, this application provides a multi-person collaboration-based resource processing method. This application also relates to a multi-person collaboration-based resource processing apparatus and system, a computing device, a computer-readable storage medium, and a computer program. The multi-person collaboration-based resource processing method, apparatus, and system, the computing device, the computer-readable storage medium, and the computer program are described in detail in the following embodiments one by one.

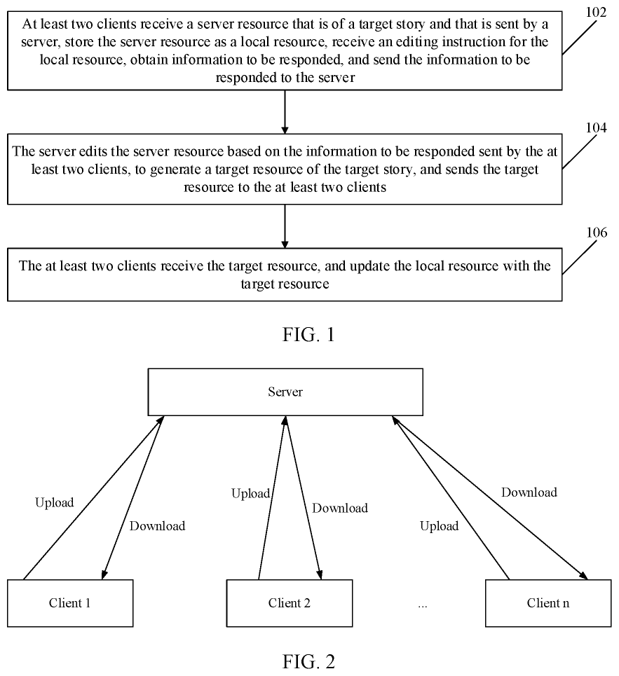

FIG. 1 is a flowchart of a multi-person collaboration-based resource processing method according to an embodiment of this application. The method is applied to a storyboard collaborative creation system, and the system includes a server device and at least two client devices. The method specifically includes the following steps:

Step 102: The at least two client devices receive a server resource that is of a target story and that is sent by the server device, store the server resource as a local resource, receive an editing instruction for the local resource, obtain information to be responded, and send the information to be responded to the server device.

The multi-person collaboration-based resource processing method provided in this application is applied to the storyboard collaborative creation system, that is, a plurality of users may perform material resource shooting and material resource editing on a same story by using a storyboard video editor, may plan a subsequent plot while performing shooting, and use a storyboard script of the story as a core. Based on this, the plurality of persons edit the storyboard script in real time through collaboration. Different creators may freely perform an operation such as creating, deleting, editing, or sorting on a scene, a shot, and a take in the story by shooting a resource or importing a resource. Different creators may freely edit a visual and perform shooting, and all users may perform creation in real time based on latest data.

Based on this, the target story is a story simultaneously processed by a plurality of users. The server resource of the target story is latest data that is of the target story and that is sent by the server device. The server resource is real-time latest data of the target story, and may include all resources related to the target story, such as a video, a picture, a visual, audio, and text.

Each client device receives the server resource that corresponds to the target story and that is sent by the server device, stores the server resource as the local resource corresponding to the client device, and stores the server resource as the local resource. Therefore, it can be ensured that the client device may perform corresponding modification on the resource in an offline state, and does not need to be in an online state in real time.

After the client device stores the server resource as the local resource, specifically, the client device stores the server resource to an editing means in the storyboard video editor. The user may edit the local resource, for example, modify a title of a shot, add description information to the shot, and add a new visual. After performing editing based on the local resource, the client device may obtain the information to be responded. The information to be responded is specifically information that needs to be submitted to the server device after the local resource is modified. For example, if the local resource is represented as A, the user performs corresponding modification based on the local resource A, and the modified part is represented as B, the modified part B is the information to be responded. In other words, the information to be responded is information about a difference between the local resource and a resource obtained after the local resource is edited. After obtaining the information to be responded in the storyboard video editor of the client device, the client device needs to submit the information to be responded to the server device. The server device performs corresponding processing on the server resource with reference to the information to be responded sent by each client device.

In actual application, the server device may be simultaneously connected to a plurality of client devices, and simultaneously store a plurality of stories. To help distinguish between stories connected to client devices, before the receiving, by the at least two client devices, a server resource that is of a target story and that is sent by the server device, the method further includes:
creating, by the server device, the target story, and generating a target story identifier of the target story;
sending, by the at least two client devices, a connection instruction for the target story, where the connection instruction carries a user identifier; and
establishing, by the server device, a communication connection to each of the at least two client devices based on a user identifier of each client device.

In actual application, there is an administrator client device in the at least two client devices, and the administrator client device creates the target story on the server device, and generates the target story identifier of the target story while creating the target story.

Then, the client device sends the connection instruction for the target story, where the connection instruction carries the user identifier. It should be noted that, in this application, the user identifier is associated with the target story identifier of the target story, that is, the target story is associated with the user, and a same user may edit a same target story by using different client devices. For example, a user Zhang San may edit a story A by using a mobile phone, and may also edit the story A by using a tablet computer.

After receiving the connection instruction of the client device, the server device establishes an association relationship between the user identifier in the connection instruction and the target story identifier. In this case, a communication connection is established between the server device and the client device.

In actual application, a client device used by each user has some resources of the target story. For example, a user Zhang San is responsible for taking a first shot in the target story, and a user Li Si is responsible for taking a second shot in the target story. To facilitate unified resource management, resources uploaded by all the client devices need to be integrated on the server device. Based on this, after the establishing, by the server device, a communication connection to each of the at least two client devices based on a user identifier of each client device, the method further includes:
separately obtaining, by the at least two client devices, a client device resource for the target story based on a storyboard video editor, and uploading the client device resource to the server device; and
receiving, by the server device, the client device resources sent by the at least two client devices, generating the server resource of the target story based on the client device resources sent by the at least two client devices, and sending the server resource to the at least two client devices.

The storyboard video editor is specifically a video editor with a storyboard function, a storyboard may be planned and designed in the storyboard editor, and a corresponding material resource may be shot based on the storyboard. The user may design a storyboard for the target story in the storyboard video editor. After designing storyboard content, the user may invoke a shooting means of the storyboard video editor to perform shooting, so as to obtain the client device resource corresponding to the current client device and the target story. The client device resource is a material resource that is shot or set by the current client device, for example, if Zhang San is responsible for a first shot of a target story A, and shoots five materials for the first shot, the five materials of the first shot are client device resources corresponding to Zhang San. If Li Si is responsible for a second shot of the target story A, and draws a visual and shoots three materials for the second shot, the visual and the three materials of the second shot are client device resources corresponding to Li Si. Each client device uploads the client device resource corresponding to the client device to the server device, so that the server device integrates all the client device resources.

After receiving the client device resources sent by all the client device, the server device integrates the client device resources based on specific content of all the client device resource to generate the server resource of the target story. For example, the five materials of the first shot that are sent by Zhang San, the visual and the three materials of the second shot that are sent by Li Si, and the like are received for the target story A. After all the client device resources are integrated and combined, the server resource is obtained and includes two shots, where a first shot includes five materials, and a second shot includes one visual and three materials. After generating the server resource, the server device sends the server resource to each client device, to synchronize, between the client devices, data that is shot or edited through collaboration.

It should be noted that resource uploading, storing, and downloading are all managed by the server device, that is, after the user uploads the local resource to the server device and the resources are combined by the server device, another user downloads a resource from the server device, and the resource cannot be directly transferred between users.

FIG. 2 is a schematic diagram of exchanging data between a client device and a server device according to an embodiment of this application. As shown in FIG. 2, a client device 1 to a client device n each upload a client device resource in a current client device to a server device, the client device resources sent by all the client devices are organized and combined on the server device to obtain a server resource, and then the server resource is sent to each client device, to synchronize the server resource between the client devices in real time.

In actual application, the uploading, by the at least two client devices, the client device resource to the server device includes:
actively uploading, by the at least two client devices, the client device resource to the server device; or
uploading, by the at least two client devices, the client device resource to the server device in response to an upload instruction.

Specifically, in a process in which the client device uploads the client device resource to the server device, the client device may actively upload the client device resource. For example, after the client device hand-draws a shot visual or shoots a segment of video, the client device may actively upload the visual or the shot video resource to the server device when the client device completes hand-drawing of the shot visual or completes shooting of the video. Alternatively, the client device may passively upload the client device resource, that is, after the user hand-draws a visual or completes shooting of a video resource, the user manually taps an upload button to trigger the upload instruction, and the client device uploads the client device resource to the server device in response to the upload instruction.

Preferably, in actual application, content such as a picture or text occupies a small amount of storage space, and a video occupies a large amount of storage space. Therefore, to improve resource upload efficiency and save upload resources (for example, traffic), for a client device resource such as a picture type and a text type with a file size less than or equal to a preset threshold, the client device resource may be actively uploaded to the server device; and for a client device resource such as a video type with a file size greater than the preset threshold, the user may trigger the upload instruction, to upload the client device resource to the server device.

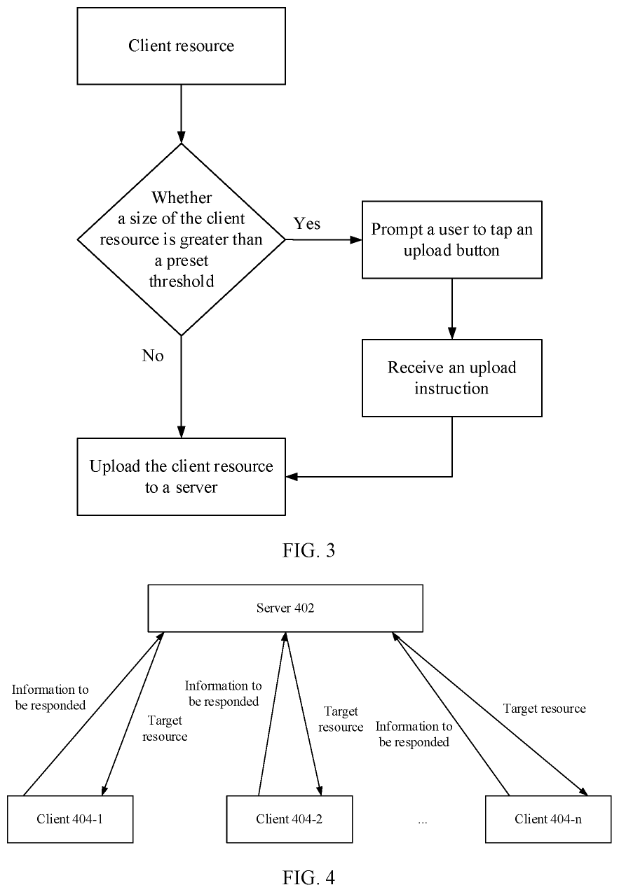

FIG. 3 is a schematic flowchart of uploading a client device resource to a server device according to an embodiment of this application. As shown in FIG. 3, after the client device resource is obtained, it is determined whether a size of the client device resource is greater than a preset threshold. If no, the client device resource is directly uploaded to the server device. If yes, a user is prompt to tap an upload button. After an upload instruction sent because the user taps the upload button is received, the client device resource is uploaded to the server device.

Step 104: The server device edits the server resource based on the information to be responded sent by the at least two client devices, to generate a target resource of the target story, and sends the target resource to the at least two client devices.

After receiving the information to be responded sent by each client device, the server device edits the server resource in the server device based on the information to be responded, and after completing editing, generates the target resource corresponding to the target story. For example, the server resource is A1. In this case, the server device receives information to be responded B1, B2, and B3 that are sent by three client devices, sequentially edits the server resource A1 based on the information to be responded B1, B2, and B3, finally obtains a target resource A2 corresponding to the target story, and sends the target resource A2 to each client device to complete resource synchronization, so that each client device obtains the latest target resource A2 in real time.

In actual application, because a plurality of client devices may simultaneously edit the server resource, the server device needs to edit the server resource based on the information to be responded sent by each client device. To avoid a conflict, the editing, by the server device, the server resource based on the information to be responded sent by the at least two client devices, to generate a target resource of the target story includes:
obtaining, by the server device, an information receiving time of information to be responded sent by each client device, determining a processing sequence of each information to be responded based on the information receiving time of the information to be responded, and editing the server resource based on the processing sequence and a preset conflict policy, to generate the target resource of the target story.

Specifically, after the server device receives the information to be responded, a same resource may have different modified content. For example, for a first shot in a storyboard, a shot title of the first shot in the server resource is “square”, the title of the first shot in information to be responded 1 sent by the user Zhang San is changed to “playground”, and the title of the first shot in information to be responded 2 sent by the user Li Si is changed to “football field”. When both the information to be responded of Zhang San and the information to be responded of Li Si are sent to the server device, it is determined that modification to the title of the first shot in the information to be responded of Zhang San and the information to be responded of Li Si are conflicted. In this case, it is first necessary to determine the information receiving time of each information to be responded, and determine the processing sequence of each information to be responded based on the information receiving time. For a same server resource version, if a same parameter in at least two pieces of information to be responded is modified, the server device accepts only editing of the first piece of information to be responded, and rejects modification in other information to be responded.

In a specific implementation provided in this application, that the server resource is the first shot and the second shot in the storyboard is used as an example, where a server resource version number is V1, and a server resource instance is shown in the following Table 1.

TABLE 1

| | Title of | Description | Title of | Description |
|---|---|---|---|---|
| Server resource | the first | information of | the second | information of |
| version | shot | the first shot | shot | the second shot |
| V1 | Square | The children | Sports | The athletes are |
| | | are playing | meeting | racing |
| | | soccer | | |

The server device receives the information to be responded 1 and the information to be responded 2 that are sent by the two client devices. A receiving time of the information to be responded 1 is T1, a receiving time of the information to be responded 2 is T2, and T1 is earlier than T2. For modified content in the information to be responded 1 and the information to be responded 2, refer to the following Table 2. Content marked with “x” in the following Table 2 indicates that the parameter is not modified.

TABLE 2

| Information | | Description | Title of | Description |
|---|---|---|---|---|
| to be | Title of the | information of | the second | information of |
| responded | first shot | the first shot | shot | the second shot |
| 1 | Football | x | Race | x |
| | field | | | |
| 2 | Playground | There are many | x | x |
| | | people | | |
| | | exercising | | |
| | | on the | | |
| | | playground | | |

The title of the first shot and the title of the second shot are modified in the information to be responded 1. The server device first receives the information to be responded 1, and modifies the server resource of the version V1 based on the information to be responded 1 to obtain a server resource V2 shown in the following Table 3.

TABLE 3

| Server | | Description | Title of | Description |
|---|---|---|---|---|
| resource | Title of the | information of | the second | information of |
| version | first shot | the first shot | shot | the second shot |
| V1 | Square | The children are | Sports | The athletes are |
| | | playing soccer | meeting | racing |
| V2 | Football | The children are | Race | The athletes are |
| | field | playing soccer | | racing |

Modification in the information to be responded 2 is based on the server resource of the version V1. The title of the first shot and the description information of the first shot in the server resource of the version V1 are modified in the information to be responded 2. In this case, the title of the first shot in the server resource of the version V2 is different from that in the version V1, and the description information of the first shot in the version V2 is the same as that in the version V1. In this case, modification to the title of the first shot in the information to be responded 2 is rejected, and modification to the description information of the first shot in the information to be responded 2 is accepted. In this case, the server resource V3 is obtained, as shown in the following Table 4.

TABLE 4

| Server | | Description | Title of | Description |
|---|---|---|---|---|
| resource | Title of the | information of | the second | information of |
| version | first shot | the first shot | shot | the second shot |
| V1 | Square | The children are | Sports | The athletes are |
| | | playing soccer | meeting | racing |
| V2 | Football | The children are | Race | The athletes are |
| | field | playing soccer | | racing |
| V3 | Football | There are many | Race | The athletes are |
| | field | people exercising | | racing |
| | | on the | | |
| | | playground | | |

In this case, the client device resource of the version V3 is the target resource, and the target resource is sent to each client device connected to the server device.

Step 106: The at least two client devices receive the target resource, and update the local resource with the target resource.

After receiving the target resource sent by the server device, the client device updates the previously stored local resource with the target resource, and uses the latest target resource as a basis for subsequent modification, that is, in subsequent modification, modification needs to be performed based on the target resource, to avoid a version conflict between the modified content.

In actual application, the user is connected to the server device by using the client device, that is, the user jointly participates in creation of the target story as a collaborative creator of the target story. Based on this, the method further includes:
breaking, by the server device, a communication connection to a first client device.

The first client device is specifically a client device used by a user who no longer participates in collaborative creation of the target story. When a specific user no longer participates in collaborative creation of the target story, the server device breaks a communication connection to the first client device. Specifically, the server device disconnects an association relationship between the target story identifier and a user identifier that uses the first client device.

Specifically, the breaking, by the server device, a communication connection to a first client device includes:
receiving, by the server device, a communication disconnection instruction sent by the first client device, and breaking the communication connection to the first client device in response to the communication disconnection instruction; or
receiving, by the server device, a client device disconnection instruction sent by an administrator client device, and breaking the communication connection to the first client device in response to the client device disconnection instruction, where the client device disconnection instruction carries a user identifier of the first client device.

Specifically, if the user exits collaborative creation of the target story, the user may actively initiate the communication disconnection instruction, that is, the user actively exits collaborative creation of the target story. After receiving the communication disconnection instruction, the server device performs, based on the user identifier carried in the communication disconnection instruction, an operation of disconnecting the association relationship between the target story identifier and the user identifier.

In actual application, an administrator of the target story may further remove a user corresponding to the first client device from collaborative creation of the target story. In this case, the administrator client device sends the client device disconnection instruction, where the client device disconnection instruction carries the user identifier of the first client device. The server device breaks the communication connection to the first client device, that is, the server device performs an operation of breaking off an association relationship between the target story identifier and the user identifier.

The multi-person collaboration-based resource processing method provided in this application is applied to a storyboard collaborative creation system, and the system includes a server device and at least two client devices. The at least two client devices receive a server resource that is of a target story and that is sent by the server device, store the server resource as a local resource, receive an editing instruction for the local resource, obtain information to be responded, and send the information to be responded to the server device; the server device edits the server resource based on the information to be responded sent by the at least two client devices, to generate a target resource of the target story, and sends the target resource to the at least two client devices; and the at least two client devices receive the target resource, and update the local resource with the target resource. According to the multi-person collaboration-based resource processing method provided in an embodiment of this application, when a video is created through multi-person collaboration, a plurality of creators can simultaneously edit a same resource, and update a server resource on the server device based on different information to be responded, to support multi-person collaboration during video creation, thereby improving collaborative processing efficiency and improving user experience.

FIG. 4 is a schematic architectural diagram of a multi-person collaboration-based resource processing system. As shown in FIG. 4, the system includes a server device 402 and at least two client devices 404.

The at least two client devices 404 are configured to receive a server resource that is of a target story and that is sent by the server device 402, store the server resource as a local resource, receive an editing instruction for the local resource, obtain information to be responded, and send the information to be responded to the server device 402.

The server device 402 is configured to edit the server resource based on the information to be responded sent by the at least two client devices 404, to generate a target resource of the target story, and send the target resource to the at least two client devices 404.

The at least two client devices 404 are further configured to receive the target resource, and update the local resource with the target resource.

Optionally, the server device 402 is configured to create the target story, and generate a target story identifier of the target story;

the at least two client devices 404 are configured to send a connection instruction for the target story, where the connection instruction carries a user identifier; and

the server device 402 is further configured to establish a communication connection to each of the at least two client devices 404 based on a user identifier of each client device 404.

Optionally, the at least two client devices 404 are further configured to separately obtain a client device resource for the target story based on a storyboard video editor, and upload the client device resource to the server device 402; and
the server device 402 is further configured to receive the client device resources sent by the at least two client devices 404, generate the server resource of the target story based on the client device resource sent by the at least two client devices 404, and send the server resource to the at least two client devices 404.

Optionally, the at least two client devices 404 are further configured to actively upload the client device resource to the server device 402; or
the at least two client devices 404 are further configured to upload the client device resource to the server device 402 in response to an upload instruction.

Optionally, the server device 402 is further configured to obtain an information receiving time of information to be responded sent by each client device 404, determine a processing sequence of each information to be responded based on the information receiving time of the information to be responded, and edit the server resource based on the processing sequence and a preset conflict policy, to generate the target resource of the target story.

Optionally, the server device 402 is further configured to break a communication connection to a first client device.

Optionally, the server device 402 is further configured to receive a communication disconnection instruction sent by the first client device, and break the communication connection to the first client device in response to the communication disconnection instruction; or
the server device 402 is further configured to receive a client device disconnection instruction sent by an administrator client device, and break the communication connection to the first client device in response to the client device disconnection instruction, where the client device disconnection instruction carries a user identifier of the first client device.

The multi-person collaboration-based resource processing system provided in this application includes a server device and at least two client devices. The at least two client devices are configured to receive a server resource that is of a target story and that is sent by the server device, store the server resource as a local resource, receive an editing instruction for the local resource, obtain information to be responded, and send the information to be responded to the server device; the server device is configured to edit the server resource based on the information to be responded sent by the at least two client devices, to generate a target resource of the target story, and sends the target resource to the at least two client devices; and the at least two client devices are further configured to receive the target resource, and update the local resource with the target resource. According to the multi-person collaboration-based resource processing system provided in an embodiment of this application, when a video is created through multi-person collaboration, a plurality of creators can simultaneously edit a same resource, and update a server resource on the server device based on different information to be responded, to support multi-person collaboration during video creation, thereby improving collaborative processing efficiency and improving user experience.

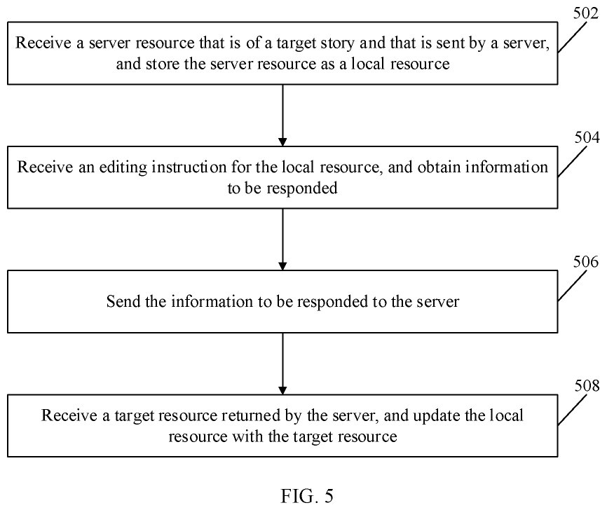

FIG. 5 shows a multi-person collaboration-based resource processing method according to an embodiment of this application. The method is applied to at least two client devices. For each client device, the method includes step 502 to step 508.

Step 502: Receive a server resource that is of a target story and that is sent by a server device, and store the server resource as a local resource.

Step 504: Receive an editing instruction for the local resource, and obtain information to be responded.

Step 506: Send the information to be responded to the server device.

Step 508: Receive a target resource returned by the server device, and update the local resource with the target resource.

The multi-person collaboration-based resource processing method provided in this embodiment of this application is applied to each of at least two client devices, including: receiving a server resource that is of a target story and that is sent by a server device, and storing the server resource as a local resource; receiving an editing instruction for the local resource, and obtaining information to be responded; sending the information to be responded to the server device; and receiving a target resource returned by the server device, and updating the local resource with the target resource. According to the multi-person collaboration-based resource processing method provided in this application, video editing information of the client device is synchronized to the server device, so that the server device can process submitted video editing information and synchronize the video editing information to another client device, to implement multi-person real-time collaborative working on a resource.

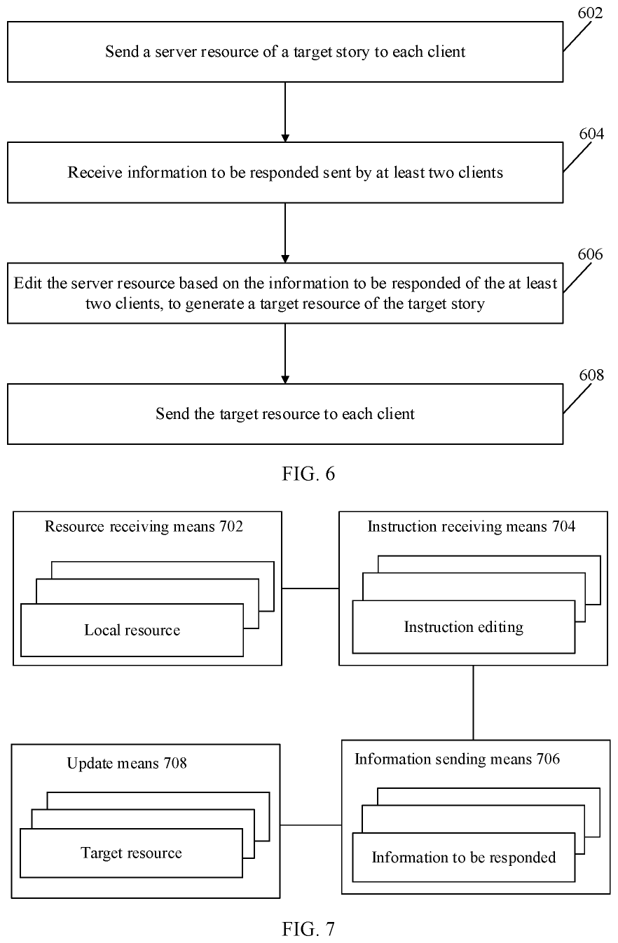

FIG. 6 shows a multi-person collaboration-based resource processing method according to an embodiment of this application. The method is applied to a server device, and specifically includes step 602 to step 608.

Step 602: Send a server resource of a target story to each client device.

Step 604: Receive information to be responded sent by at least two client devices.

Step 606: Edit the server resource based on the information to be responded of the at least two client devices, to generate a target resource of the target story.

Step 608: Send the target resource to each client device.

The multi-person collaboration-based resource processing method provided in this embodiment of this application is applied to a server device, including: sending a server resource of a target story to each client device; receiving information to be responded sent by at least two client devices; editing the server resource based on the information to be responded of the at least two client devices, to generate a target resource of the target story; and sending the target resource to each client device. According to the multi-person collaboration-based resource processing method provided in this application, the server resource is edited based on the information to be responded submitted by all the client devices, and video editing requests of all the client devices for an initial video are sequentially responded to, thereby efficiently processing video editing information sent by a plurality of persons in real time.

Corresponding to the foregoing embodiment of the multi-person collaboration-based resource processing method applied to at least two client devices, this application further provides an embodiment of a multi-person collaboration-based resource processing apparatus. FIG. 7 is a schematic diagram of a structure of a multi-person collaboration-based resource processing apparatus according to an embodiment of this application. The apparatus is applied to at least two client devices. For each client device, as shown in FIG. 7, the apparatus includes:
a resource receiving means 702, configured to receive a server resource that is of a target story and that is sent by a server device, and store the server resource as a local resource;
an instruction receiving means 704, configured to receive an editing instruction for the local resource, and obtain information to be responded;
an information sending means 706, configured to send the information to be responded to the server device; and
an update means 708, configured to receive a target resource returned by the server device, and update the local resource with the target resource.

The multi-person collaboration-based resource processing apparatus provided in this embodiment of this application is applied to each of at least two client devices, including: receiving a server resource that is of a target story and that is sent by a server device, and storing the server resource as a local resource; receiving an editing instruction for the local resource, and obtaining information to be responded; sending the information to be responded to the server device; and receiving a target resource returned by the server device, and updating the local resource with the target resource. According to the multi-person collaboration-based resource processing apparatus provided in this application, video editing information of the client device is synchronized to the server device, so that the server device can process submitted video editing information and synchronize the video editing information to another client device, to implement multi-person real-time collaborative working on a resource.

The foregoing describes a schematic solution of a multi-person collaboration-based resource processing apparatus applied to at least two client devices in this embodiment. It should be noted that the technical solution of the multi-person collaboration-based resource processing apparatus belongs to a same concept as the foregoing technical solution of the multi-person collaboration-based resource processing method applied to at least two client devices. For details not described in the technical solution of the multi-person collaboration-based resource processing apparatus, refer to descriptions of the foregoing technical solution of the multi-person collaboration-based resource processing method applied to at least two client devices.

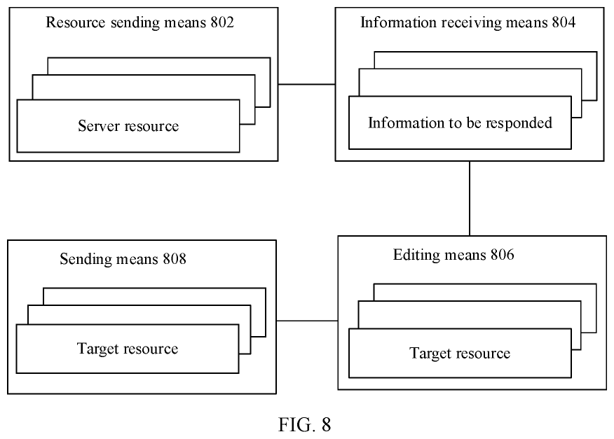

Corresponding to the foregoing embodiment of the multi-person collaboration-based resource processing method applied to a server device, this application further provides an embodiment of a multi-person collaboration-based resource processing apparatus. FIG. 8 is a schematic diagram of a structure of a multi-person collaboration-based resource processing apparatus according to an embodiment of this application. The apparatus is applied to a server device. As shown in FIG. 8, the apparatus includes:
a resource sending means 802, configured to send a server resource of a target story to each client device;
an information receiving means 804, configured to receive information to be responded sent by at least two client devices;
an editing means 806, configured to edit the server resource based on the information to be responded of the at least two client devices, to generate a target resource of the target story; and
a sending means 808, configured to send the target resource to each client device.

The multi-person collaboration-based resource processing apparatus provided in this embodiment of this application is applied to a server device, including: sending a server resource of a target story to each client device; receiving information to be responded sent by at least two client devices; editing the server resource based on the information to be responded of the at least two client devices, to generate a target resource of the target story; and sending the target resource to each client device. According to the multi-person collaboration-based resource processing apparatus provided in this application, the server resource is edited based on the information to be responded submitted by all the client devices, and video editing requests of all the client devices for an initial video are sequentially responded to, thereby efficiently processing video editing information sent by a plurality of persons in real time.

The foregoing describes a schematic solution of a multi-person collaboration-based resource processing apparatus applied to a server device in this embodiment. It should be noted that the technical solution of the multi-person collaboration-based resource processing apparatus belongs to a same concept as the foregoing technical solution of the multi-person collaboration-based resource processing method applied to a server device. For details not described in the technical solution of the multi-person collaboration-based resource processing apparatus, refer to descriptions of the foregoing technical solution of the multi-person collaboration-based resource processing method applied to a server device.

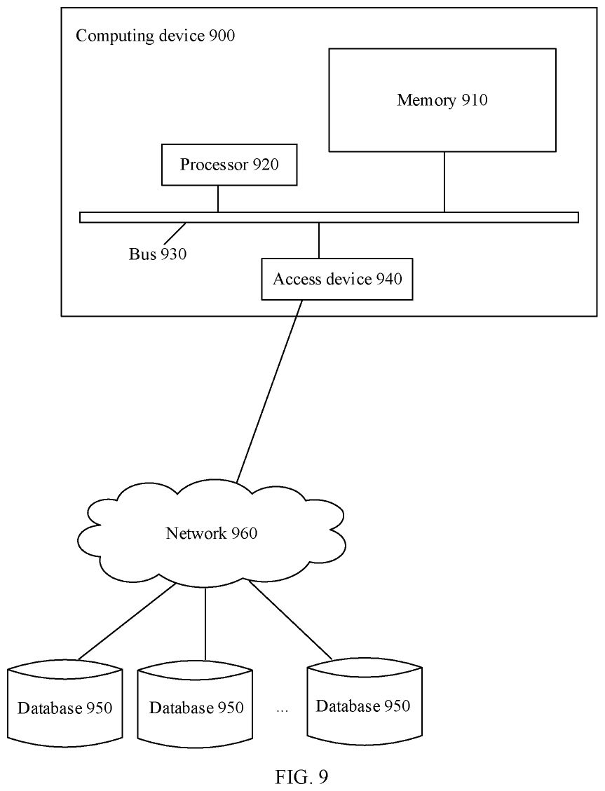

FIG. 9 is a block diagram of a structure of a computing device 900 according to an embodiment of this application. Components of the computing device 900 include but are not limited to a memory 910 and a processor 920. The processor 920 is connected to the memory 910 by using a bus 930. A database 950 is configured to store data.

The computing device 900 further includes an access device 940. The access device 940 enables the computing device 900 to perform communication by using one or more networks 960. Examples of these networks include a public switched telephone network (PSTN), a local area network (LAN), a wide area network (WAN), a private area network (PAN), or a combination of communication networks such as the Internet. The access device 940 may include one or more of any type of wired or wireless network interface (for example, a network interface card (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of this application, the foregoing components of the computing device 900 and other components not shown in FIG. 9 may be connected to each other, for example, by using a bus. It should be understood that the block diagram of the structure of the computing device shown in FIG. 9 is merely used as an example instead of a limitation on the scope of this application. A person skilled in the art can add or replace other components as required.

The computing device 900 may be any type of stationary or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smartwatch or smart glasses), or another type of mobile device, or a stationary computing device such as a desktop computer or a PC. The computing device 900 may be alternatively a mobile or stationary server device.

When the processor 900 executes computer instructions, steps of the multi-person collaboration-based resource processing method are implemented.

The foregoing describes a schematic solution of a computing device in this embodiment. It should be noted that the technical solution of the computing device belongs to a same concept as the foregoing technical solution of the multi-person collaboration-based resource processing method. For details not described in detail in the technical solution of the computing device, refer to descriptions of the foregoing technical solution of the multi-person collaboration-based resource processing method.

An embodiment of this application further provides a computer-readable storage medium, where the computer-readable storage medium stores computer instructions, and when the computer instructions are executed by a processor, steps of the multi-person collaboration-based resource processing method are implemented.

The foregoing describes a schematic solution of a computer-readable storage medium in this embodiment. It should be noted that the technical solution of the storage medium belongs to a same concept as the foregoing technical solution of the multi-person collaboration-based resource processing method. For details not described in detail in the technical solution of the storage medium, refer to descriptions of the foregoing technical solution of the multi-person collaboration-based resource processing method.

An embodiment of this application further provides a computer program, where when the computer program is executed on a computer, the computer is enabled to perform steps of the multi-person collaboration-based resource processing method.

The foregoing describes a schematic solution of a computer program in this embodiment. It should be noted that the technical solution of the computer program belongs to a same concept as the foregoing technical solution of the multi-person collaboration-based resource processing method. For details not described in detail in the technical solution of the computer program, refer to descriptions of the foregoing technical solution of the multi-person collaboration-based resource processing method.

Specific embodiments of this application are described above. Other embodiments fall within the scope of the appended claims. In some cases, actions or steps described in the claims may be performed in an order different from that in the embodiments and desired results may still be achieved. In addition, processes described in the accompanying drawings do not necessarily require shown specific orders or sequences to achieve the desired results. In some implementations, multitasking and parallel processing are also possible or may be advantageous.

The computer instructions include computer program code, and the computer program code may be in a source code form, an object code form, an executable file form, an intermediate form, or the like. The computer-readable medium may include: any entity or apparatus capable of carrying the computer program code, a recording medium, a USB flash drive, a removable hard disk, a magnetic disk, a compact disc, a computer memory, a read-only memory (ROM), a random access memory (RAM), an electrical carrier signal, a telecommunication signal, a software distribution medium, or the like. It should be noted that the content included in the computer-readable medium can be appropriately added or deleted depending on requirements of the legislation and patent practice in a jurisdiction. For example, in some jurisdictions, according to the legislation and patent practice, the computer-readable medium does not include an electrical carrier signal or a telecommunication signal.

It should be noted that, for brief description, the foregoing method embodiments are represented as a combination of a series of actions. However, a person skilled in the art should be aware that this application is not limited to the described order of the actions, because some steps may be performed in other orders or simultaneously according to this application. In addition, a person skilled in the art should also be aware that the embodiments described in this specification are all example embodiments, and used actions and means are not necessarily mandatory to this application.

In the foregoing embodiments, the descriptions of the embodiments have respective focuses. For a part that is not described in detail in a specific embodiment, refer to related descriptions in other embodiments.

The example embodiments of this application disclosed above are merely intended to help describe this application. In the optional embodiments, not all details are described in detail, and the present invention is not limited to only the specific implementations. Clearly, many modifications and variations may be made based on the content of this application. In this application, these embodiments are selected and specifically described to better explain the principle and actual application of this application, so that a person skilled in the art can well understand and use this application. This application is only subject to the claims and a full scope and equivalents thereof.

1. A method of processing resources based on multi-person collaboration, applied to a server device, and the method comprises:
creating a target story and generating a target story identifier of identifying the target story;
receiving connection instructions with respect to the target story from a plurality of client devices, wherein each of the connect instructions comprises a user identifier of identifying a user associated with each of the plurality of client devices;
establishing communication connections with the plurality of client devices in response to receiving the connection instructions from the plurality of client devices;
establishing an association relationship between the target story identifier and the plurality of user identifiers;
receiving client resources of the target story from the plurality of client devices, wherein a client resource from one of the plurality of client devices comprises a material resource that is shot for the target story using a storyboard video editor by the one of the plurality of client devices, wherein the material resource comprises a video, a picture, audio and text;
generating a server resource of the target story based on the client resources received from the plurality of client devices; and
sending the server resource to the plurality of client devices, wherein the plurality of client devices are configured to simultaneously shoot or edit material resources for the target story using respective storyboard video editors.

2.-4. (canceled)

5. The method according to claim 1, further comprising:
editing the server resource based on information received from the plurality of client devices to generate a target resource of the target story, wherein the information indicates modifications made to the resources of the target story by the plurality of client devices;
obtaining receipt time points of receiving the information from the plurality of client devices, respectively;
determining a processing sequence of processing the information based on the receipt time points of receiving the information;
editing the server resource based on the processing sequence to generate a target resource of the target story; and
sending the target resource to the plurality of client devices for further collaboratively working on the target story by the plurality of client device.

6. The method according to claim 1, further comprising:
breaking a communication connection with a first client device in response to receiving a disconnection instruction, wherein the first client device is among the plurality of client devices.

7.-12. (canceled)

13. A server computing device, comprising a memory, a processor, wherein computer instructions are stored in the memory and executable by the processor, and wherein the computer instructions, when executed by the processor, cause the processor to implement operations comprising:
creating a target story and generating a target story identifier of identifying the target story;
receiving connection instructions with respect to the target story from a plurality of client devices, wherein each of the connect instructions comprises a user identifier of identifying a user associated with each of the plurality of client devices;
establishing communication connections with the plurality of client devices in response to receiving the connection instructions from the plurality of client devices;
establishing an association relationship between the target story identifier and the plurality of user identifiers;
receiving client resources of the target story from the plurality of client devices, wherein a client resource from one of the plurality of client devices comprises a material resource that is shot for the target story using a storyboard video editor by the one of the plurality of client devices, wherein the material resource comprises a video, a picture, audio and text;
generating a server resource of the target story based on the client resources received from the plurality of client devices; and
sending the server resource to the plurality of client devices, wherein the plurality of client devices are configured to simultaneously shoot or edit material resources for the target story using respective storyboard video editors.

14. A non-transitory computer-readable storage medium, wherein the computer-readable storage medium stores computer instructions, and wherein the computer instructions, when executed by a processor, cause the process to implement operations comprising:
creating a target story and generating a target story identifier of identifying the target story;
receiving connection instructions with respect to the target story from a plurality of client devices, wherein each of the connect instructions comprises a user identifier of identifying a user associated with each of the plurality of client devices;
establishing communication connections with the plurality of client devices in response to receiving the connection instructions from the plurality of client devices;
establishing an association relationship between the target story identifier and the plurality of user identifiers;
receiving client resources of the target story from the plurality of client devices, wherein a client resource from one of the plurality of client devices comprises a material resource that is shot for the target story using a storyboard video editor by the one of the plurality of client devices, wherein the material resource comprises a video, a picture, audio and text;
generating a server resource of the target story based on the client resources received from the plurality of client devices; and
sending the server resource to the plurality of client devices, wherein the plurality of client devices are configured to simultaneously shoot or edit material resources for the target story using respective storyboard video editors.

15. (canceled)

16. The server computing device according to claim 13, the operations further comprising:
receiving information from the plurality of client devices, wherein the information indicates modifications made to the material resources of the target story by the plurality of client devices; and
editing the server resource based on the information received from the plurality of client devices to generate a target resource of the target story.

17. The server computing device according to claim 16, the operations further comprising:
obtaining receipt time points of receiving the information from the plurality of client devices, respectively; and
determining a processing sequence of processing the information received from the plurality of client devices based on the receipt time points.

18. The server computing device according to claim 17, the operations further comprising:
editing the server resource in the processing sequence to generate the target resource of the target story; and
sending the target resource to the plurality of client devices for further collaboratively working on the target story by the plurality of client devices.

19. The non-transitory computer-readable storage medium according to claim 14, the operations further comprising:
receiving information from the plurality of client devices, wherein the information indicates modifications made to the material resources of the target story by the plurality of client devices; and
editing the server resource based on the information received from the plurality of client devices to generate a target resource of the target story.

20. The non-transitory computer-readable storage medium according to claim 19, the operations further comprising:
obtaining receipt time points of receiving the information from the plurality of client devices, respectively; and
determining a processing sequence of processing the information from the plurality of client devices based on the receipt time points.

21. The non-transitory computer-readable storage medium according to claim 20, the operations further comprising:
editing the server resource in the processing sequence to generate the target resource of the target story; and
sending the target resource to the plurality of client devices for further collaboratively working on the target story by the plurality of client devices.
